(19) United States
(12) Patent Application Publication
(10) Pub. No.: US 2024/0251414 A1
(43) Pub. Date: Jul. 25, 2024

(54) MAXIMUM DOWNLINK HARQ-ACK BITS DRIVEN BY UPLINK LINK ADAPTATIONS

(71) Applicant: Telefonaktiebolaget LM Ericsson (publ), Stockholm (SE)

(72) Inventors: Ping YU, Ottawa (CA); Qingchao LIU, Ottawa (CA)

(21) Appl. No.: 18/257,738

(22) PCT Filed: Dec. 22, 2021
(86) PCT No.: PCT/IB2021/062211

§ 371 Date: Jun. 15, 2023

Related U.S. Application Data
(60) Provisional application No. 63/132,077, filed on Dec. 30, 2020.

(51) Int. Cl. H04W 72/21; H04B 17/336; H04L 1/1812; H04W 72/1273

(52) U.S. Cl. CPC H04W 72/21; H04B 17/336; H04L 1/1812; H04W 72/1273

(57) ABSTRACT

A method, system and apparatus are disclosed related to DL HARQ-ACK bits driven by PUCCH/PUSCH link adaptations. In one embodiment, a network node is configured to determine a channel condition of a physical uplink channel associated with the WD: and based on the channel condition, perform an adjustment associated with the physical uplink channel to support a number of Hybrid Automatic Repeat reQuest (HARQ) bits. In one embodiment, a method implemented in a network node includes determining a channel condition of a physical uplink channel associated with the WD; and based on the channel condition, performing an adjustment associated with the physical uplink channel to support a number of Hybrid Automatic Repeat reQuest, HARQ, bits.

### FIELD

The present disclosure relates to wireless communications, and in particular, to maximum downlink (DL) Hybrid Automatic Repeat reQuest acknowledgement (HARQ-ACK) bits driven by physical uplink control channel/physical uplink shared channel (PUCCH/PUSCH) link adaptations.

### BACKGROUND

Unless DL data is for broadcast, for DL data transmitted toward a wireless device (WD), such as a user equipment, also called UE), each DL data transmission scheduled by a network node (e.g., gNB) generally requests HARQ-ACK feedback from the WD. In order to accommodate such feedback, the network node (NN) allocates one of the configured PUCCH resources or uplink control information (UCI) on PUSCH on a dedicated uplink (UL) slot with the time span for the feedback indicated as K1.

The HARQ-ACK feedbacks may contain multiple HARQ-ACK bits due to, for example, one or more of:
within one cell, the same UL slot is assigned as a feedback slot for DL data transmissions from multiple DL slots with different K1 values indicated in the DL downlink control information messages (DCIs);
if the codebook is configured as code block group based (CBGs), even one DL transmission with multiple code blocks may request multiple HARQ-ACK bits;
with DL carrier aggregations and single PUCCH group configuration, the HARQ-ACK feedbacks toward all DL data transmissions on all carrier components within the same physical downlink control channel (PDCCH) monitor window are all bundled; and/or
the multiple HARQ bits are ordered by following the 3^{rd} Generation Partnership Project (3GPP) standard; each bit may be a HARQ feedback for one specific DL transmission with ‘1’ as ACK and ‘0’ as NACK.

The HARQ-ACK may be transmitted on PUCCH. For 3GPP New Radio (NR, also called 5^{th} Generation or 5G), resource formats can be 0-4, depending on the configuration that suits the system performances. PUCCH formats 0 and 1 (configured as set 0) take up to 2 HARQ-ACK bits; while the rest of the PUCCH formats take a higher number of HARQ bits with cyclic redundancy check (CRC) bits added on top, if the number of bits is bigger than or equal to 12.

The 3GPP standard may allow multiple PUCCH resource sets with formats 2, 3 or 4, each with the maximum (max) code rate, associated to the maximum number of UCI bits (e.g., HARQ-ACK bits+scheduling request bits) as:

$$coding rate = ( total UCI bits + CRC bits ) / ( \# data symbols * \# prbs * 12 subcarriers * 2 bits per QPSK symbol ) .$$

If there is one such PUCCH resource set configured e.g., according to the coding rate formula above, the PUCCH resource in the set may take on any number of assigned HARQ bits without further code rate consideration.

If UCI on PUSCH is supported, HARQ-ACK may be transmitted on PUSCH when there is UL data to be transmitted in the same slot. PUSCH physical resource blocks (PRBs) may be allocated for the transmission based on the NN's available PRBs, the WD's power headroom (PH), the number of HARQ-ACK bits as UCI, other UCI information such as channel state information (CSI), UL data in the buffer, UL channel conditions, etc. A proper UL coding rate is determined for the allocation with a desired block error rate (BLER).

The WD's DL/UL channels may be configured based on the WD's capabilities and its traffic demands. There are applications that require much higher DL throughput than UL throughput, which may result in the use of carrier aggregations (CA) for a CA-capable WD that has multiple DL carriers, but one or a few UL carriers.

### SUMMARY

Some embodiments advantageously provide methods, systems, and apparatuses for DL HARQ-ACK bits driven by PUCCH/PUSCH link adaptations.

In one embodiment, a network node is configured to determine a channel condition of a physical uplink channel associated with the WD; and based on the channel condition, perform an adjustment associated with the physical uplink channel to support a number of Hybrid Automatic Repeat reQuest (HARQ) bits. As used herein, the term “support” is defined as controlling the maximum number of HARQ bits to that these bits can be decoded on the uplink channel with a predetermined success rate.

According to an aspect, a method implemented in a network node is provided. The method includes determining a channel condition of a physical uplink channel associated with the WD; and based on the channel condition, performing an adjustment associated with the physical uplink channel to support a number of Hybrid Automatic Repeat reQuest, HARQ, bits.

In one embodiment, the performing the adjustment comprises applying a link adaptation to the physical uplink channel to support the number of HARQ bits to transmit on the physical uplink channel. In one embodiment, the performing the adjustment comprises adjusting the number of HARQ bits based at least in part on a power headroom report from the WD. In one embodiment, the performing the adjustment comprises adjusting a number of cells configured to the WD.

In one embodiment, the performing the adjustment comprises adjusting a physical downlink control channel, PDCCH, monitoring window for the WD. In one embodiment, the determining the channel condition of the physical uplink channel is based at least in part on a target block error rate, BLER. In one embodiment, the determining the channel condition of the physical uplink channel comprises obtaining a measurement of the physical uplink channel. In one embodiment, the measurement is a measurement of a signal to interference plus noise ratio, SINR, and the physical uplink channel is a physical uplink control channel, PUCCH.

In one embodiment, the number of HARQ bits to support is a maximum number of downlink HARQ bits associated with the WD. In one embodiment, the performing the adjustment to support the number of HARQ bits when the channel condition of the physical uplink channel is unable to support the number of HARQ bits.

According to another aspect, a network node configured to communicate with a wireless device, WD, is provided. The network node comprises processing circuitry. The processing circuitry is configured to cause the network node to determine a channel condition of a physical uplink channel associated with the WD; and based on the channel condition, perform an adjustment associated with the physical uplink channel to support a number of Hybrid Automatic Repeat reQuest, HARQ, bits.

In one embodiment, the processing circuitry is configured to cause the network node to perform the adjustment by being configured to cause the network node to apply a link adaptation to the physical uplink channel to support the number of HARQ bits to transmit on the physical uplink channel. In one embodiment, the processing circuitry is configured to cause the network node to perform the adjustment by being configured to cause the network node to adjust the number of HARQ bits based at least in part on a power headroom report from the WD.

In one embodiment, the processing circuitry is configured to cause the network node to perform the adjustment by being configured to cause the network node to adjust a number of cells configured to the WD. In one embodiment, the processing circuitry is configured to cause the network node to perform the adjustment by being configured to cause the network node to adjust a physical downlink control channel, PDCCH, monitoring window for the WD.

In one embodiment, the processing circuitry is configured to cause the network node to determine the channel condition of the physical uplink channel based at least in part on a target block error rate, BLER. In one embodiment, the processing circuitry is configured to cause the network node to determine the channel condition of the physical uplink channel by being configured to cause the network node to obtain a measurement of the physical uplink channel. In one embodiment, the measurement is a measurement of a signal to interference plus noise ratio, SINR, and the physical uplink channel is a physical uplink control channel, PUCCH. In one embodiment, the number of HARQ bits to support is a maximum number of downlink HARQ bits associated with the WD. In one embodiment, the adjustment to support the number of HARQ bits is performed when the channel condition of the physical uplink channel is unable to support the number of HARQ bits.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 illustrates an example graph of required (Rx) SINR vs. maximum number of HARQ bits (BLER<=1%) according to some embodiments of the present disclosure;

FIG. 9 is a flowchart of an example process performed by a DL scheduler according to some embodiments of the present disclosure;

FIG. 10 illustrates an example of HARQ decoding BLER vs. PUSCH normalized throughput according to some embodiments of the present disclosure;

FIG. 11 illustrates an example of PUSCH BLER vs. UCI HARQ bits decoding BLER according to some embodiments of the present disclosure; and

FIG. 12 is a flowchart of an example process performed by a DL and UL scheduler according to some embodiments of the present disclosure.

### DETAILED DESCRIPTION

A higher number of DL data transmissions may demand more HARQ-ACK bits to be sent back by the WD via an UL channel in a secondary primary cell (spcell), especially when carrier aggregations are configured to the WD with potential massive DL data to be transmitted on secondary cells (scells).

However, DL performance may be significantly reduced if the primary secondary cell (pscell) has poor UL channel conditions close to the cell edge; while the DL (spcell and/or scells) has good link conditions using micro cells.

For example, when DL carrier aggregation is applied especially for frequency 1 (FR1) as pscell plus multiple frequency 2 (FR2) as scells, which are micro cells having good DL radio frequency (RF) conditions, while the pscell is at the cell edge, but has to carry a lot of DL HARQ feedback bits (in the order of several tens of bits) in the UL either on PUCCH or on PUSCH. UL PUCCH or PUSCH may not be able to meet the DL HARQ bits decoding performance metrics or keep the minimum UL data on the PUSCH. Then, the following issues may arise:
1) Poor PUCCH channel condition:
   A poor PUCCH with the desired coding rate lower than what the number of HARQ-ACK bits need may result in a NN UL decoding failure to the bundled HARQ-ACK bits, which may cause the NN to retransmit DL data that the WD has already successfully received. These unnecessary retransmissions may reduce DL throughputs and waste DL radio resources.
   Applying each of the PUCCH resources with more physical resources may reduce such risk, but may cost potentially more UL resource waste for covering occasions of the WD's poor channel conditions; while fewer physical resources may still be sufficient under other coverage areas.
2) Poor PUSCH channel condition:
   As traffic models built by statistics, there is a certain volume ratio range applied to user's DL/UL data transmissions. If UL traffic is low due to channel conditions, DL traffic may be dragged down if the basic two-way communications cannot be maintained, even in cases that the DL channels allow higher throughputs.
   A poor PUSCH channel condition may be reflected as low power headroom reported by the WD and low PUSCH signal-to-interference-plus-noise ratio (SINR) measured at the UL physical layer. UL traffic may be slowed down accordingly. In addition, each valid UL data allocation is to meet the following condition if UCI includes HARQ-ACK bits:

$$power headroom ( PH ) > PRBs for UCI bits + CRC bits + minimal UL data .$$

When the above PUSCH cannot satisfy the above condition, even if there is a good potential for a high volume of DL data transmissions, the HARQ-ACK decoding failures and/or lack of corresponding UL data transmissions may still result in poor WD DL data transmission performance.

Some example embodiments of the present disclosure may include one or more of the following steps, which may be performed at the NN:
based on the NN system configurations, provide a relation between maximum DL HARQ-ACK bits and a spcell's PUCCH/PUSCH channel conditions respectively with desired BLER tolerances, which may yield optimal cell/WD DL performances with such transmission number limits.
conduct measurements of the WD's PUCCH and PUSCH channel conditions;
apply PUCCH link adaptations toward the WD's maximum number of HARQ-ACK bits adjustment, which in turn controls the number of DL transmissions from all activated carrier components for the WD; and/or
apply PUSCH link adaptations toward the WD's HARQ-ACK UCI bits and UL data throughputs. The WD's maximum number of HARQ-ACK bits is adjusted accordingly, which in turn controls the number of DL transmissions from all activated carrier components for the WD.

In some embodiments the above 2 steps may be conducted together to make the maximum number of HARQ-ACK bits satisfy both PUCCH/PUSCH conditions.

Though descriptions of some embodiments of the present disclosure may focus on dynamic HARQ-ACK codebook (type 2), such arrangements may also apply similarly to semi-static HARQ-ACK codebook (type 1) via e.g., radio resource control (RRC) reconfigurations.

Some embodiments may advantageously provide one or more of the following:
1) Save UL radio resources: for example, each PUCCH resource (format 2, 3, or 4) can be configured with fewer physical resources without pursuing the same maximum HACK-ACK bits crossing all the spcell coverage areas, which may save the NN's UL radio resources and processing power.
2) Reliable HARQ-ACK decoding: HARQ-ACK bits are well adapted to PUCCH/PUSCH link conditions so that the WD's HARQ-ACKs under all expected UL channel conditions can be reliably decoded.
3) Avoid DL radio resource waste: the number of DL transmissions may be well adjusted based on the UL channel conditions that avoid unnecessary DL retransmissions due to possible HARQ-ACK decoding failures.
4) Better DL/UL volume coordination: a balanced DL/UL traffic may be achieved through the HARQ-ACK bits adjustment based on PUSCH capacities, contributed by the WD's power headroom report and the UL channel condition.

Before describing in detail example embodiments, it is noted that the embodiments reside primarily in combinations of apparatus components and processing steps related to DL HARQ-ACK bits driven by PUCCH/PUSCH link adaptations. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled.” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver. For DL communication, the network node is the transmitter and the receiver is the WD. For the UL communication, the transmitter is the WD and the receiver is the network node.

The term “radio measurement” used herein may refer to any measurement performed on radio signals. Radio measurements can be absolute or relative. Radio measurement may be called as signal level which may be signal quality and/or signal strength. Radio measurements can be e.g. intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc. The inter-frequency and inter-RAT measurements are carried out by the WD in measurement gaps unless the WD is capable of doing such measurement without gaps. Examples of measurement gaps are measurement gap id #0 (each gap of 6 ms occurring every 40 ms), measurement gap id #1 (each gap of 6 ms occurring every 80 ms), etc. The measurement gaps are configured at the WD by the network node.

Generally, it may be considered that the network, e.g. a signaling radio node and/or node arrangement (e.g., network node), configures a WD, in particular with the transmission resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in number of bits it may carry, e.g. information or payload bits, or total number of bits. The set of resources, and/or the resources of the sets, may pertain to the same carrier and/or bandwidth part, and/or may be located in the same slot, or in neighboring slots.

In some embodiments, control information on one or more resources may be considered to be transmitted in a message having a specific format. A message may comprise or represent bits representing payload information and coding bits, e.g., for error coding.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have at least two component channels, one for each direction.

Configuring a terminal or wireless device (WD) or node may involve instructing and/or causing the wireless device or node to change its configuration, e.g., at least one setting and/or register entry and/or operational mode. A terminal or wireless device or node may be adapted to configure itself, e.g., according to information or data in a memory of the terminal or wireless device (e.g., the indication of the resource allocation as discussed above). Configuring a node or terminal or wireless device by another device or node or a network may refer to and/or comprise transmitting information and/or data and/or instructions to the wireless device or node by the other device or node or the network, e.g., allocation data (which may also be and/or comprise configuration data) and/or scheduling data and/or scheduling grants. Configuring a terminal may include sending allocation/configuration data to the terminal indicating which modulation and/or encoding to use. A terminal may be configured with and/or for scheduling data and/or to use, e.g., for transmission, scheduled and/or allocated uplink resources, and/or, e.g., for reception, scheduled and/or allocated downlink resources. Uplink resources and/or downlink resources may be scheduled and/or provided with allocation or configuration data.

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD) may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor. In particular, configuring a terminal (e.g. WD) may comprise configuring the WD to perform certain measurements on certain subframes or radio resources and reporting such measurements according to embodiments of the present disclosure.

In some embodiments, the general term resource allocation is intended to indicate a frequency resource allocation and/or a time resource allocation.

The term time resource used herein may correspond to any type of physical resource or radio resource expressed in terms of length of time. Examples of time resources are: symbol, time slot, sub-slot, subframe, radio frame, TTI, interleaving time, etc. As used herein, in some embodiments, the terms “subframe,” “slot.” “sub-slot”, “sub-frame/slot” and “time resource” are used interchangeably and are intended to indicate a time resource and/or a time resource number.

A cell may be generally a communication cell, e.g., of a cellular or mobile communication network, provided by a node. A serving cell may be a cell on or via which a network node (the node providing or associated to the cell, e.g., base station or eNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE-standard. One or more carriers (e.g., uplink and/or downlink carrier/s and/or a carrier for both uplink and downlink) may be associated to a cell.

It may be considered for cellular communication there is provided at least one uplink (UL) connection and/or channel and/or carrier and at least one downlink (DL) connection and/or channel and/or carrier, e.g., via and/or defining a cell, which may be provided by a network node, in particular a base station or gNodeB. An uplink direction may refer to a data transfer direction from a terminal to a network node, e.g., base station and/or relay station. A downlink direction may refer to a data transfer direction from a network node, e.g., base station and/or relay node, to a terminal. UL and DL may be associated to different frequency resources, e.g., carriers and/or spectral bands. A cell may comprise at least one uplink carrier and at least one downlink carrier, which may have different frequency bands. A network node, e.g., a base station or gNodeB, may be adapted to provide and/or define and/or control one or more cells, e.g., a PCell, PSCell, SPCell and/or Scell.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

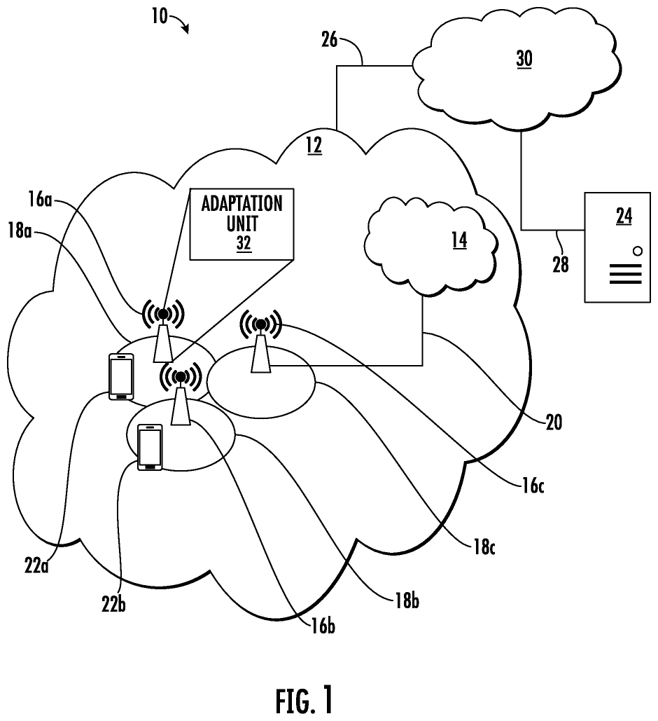

Some embodiments provide arrangements for DL HARQ-ACK bits driven by PUCCH/PUSCH link adaptations. Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an adaptation unit 32 which is configured to determine a channel condition of a physical uplink channel associated with the WD; and based on the channel condition, perform an adjustment associated with the physical uplink channel to support a number of Hybrid Automatic Repeat reQuest (HARQ) bits.

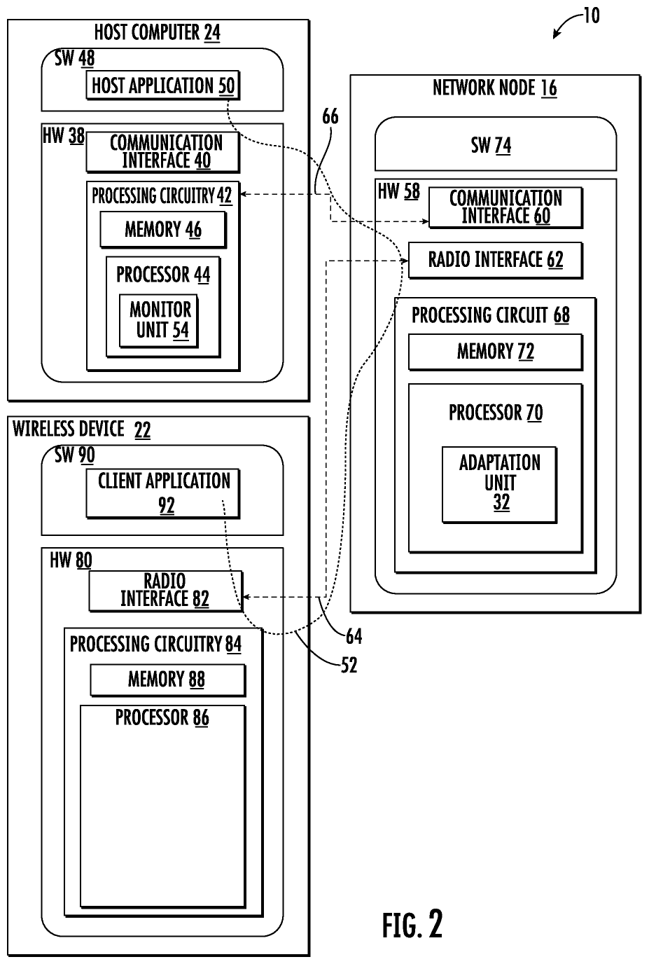

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

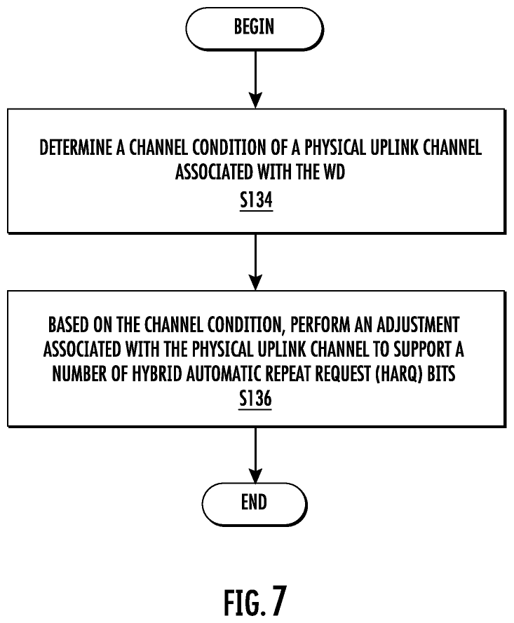

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include adaptation unit 32 configured to perform network node methods discussed herein, such as the methods discussed with reference to FIG. 7 as well as other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for

preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as adaptation unit 32, as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

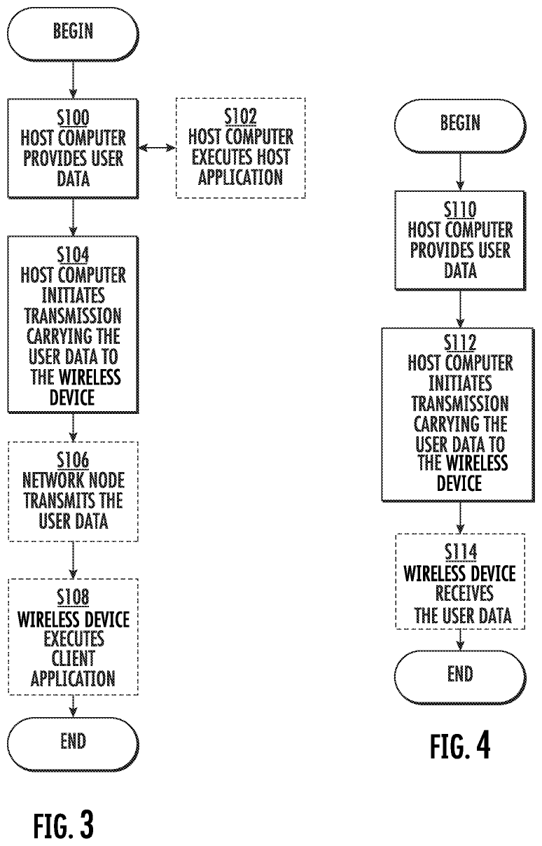

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

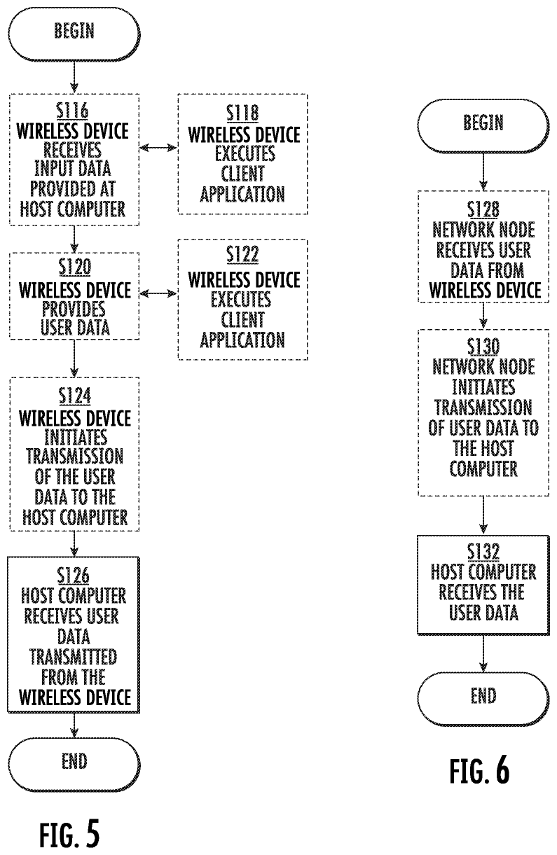

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 7 is a flowchart of an example process in a network node 16 according to some embodiments of the present disclosure. One or more Blocks and/or functions and/or methods performed by the network node 16 may be performed by one or more elements of network node 16 such as by adaptation unit 32 in processing circuitry 68, processor 70, communication interface 60, and/or radio interface 62, etc. according to the example method. The example method includes determining (Block S134), such as via adaptation unit 32, processing circuitry 68, processor 70 and/or radio interface 62, a channel condition of a physical uplink channel associated with the WD. The method includes based on the channel condition, performing (Block S136), such as via adaptation unit 32, processing circuitry 68, processor 70 and/or radio interface 62, an adjustment associated with the physical uplink channel to support a number of Hybrid Automatic Repeat reQuest (HARQ) bits.

In some embodiments, the network node 16 such as by adaptation unit 32 in processing circuitry 68, processor 70, communication interface 60, and/or radio interface 62 is configured to cause the network node 16 to apply a link adaptation to the physical uplink channel to support the number of HARQ bits to transmit on the physical uplink channel. In some embodiments, the network node 16 such as by adaptation unit 32 in processing circuitry 68, processor 70, communication interface 60, and/or radio interface 62 is configured to cause the network node 16 to adjust the number of HARQ bits based at least in part on a power headroom report from the WD.

In some embodiments, the network node 16 such as by adaptation unit 32 in processing circuitry 68, processor 70, communication interface 60, and/or radio interface 62 is configured to cause the network node 16 to adjust a number of cells configured to the WD. In some embodiments, the network node 16 such as by adaptation unit 32 in processing circuitry 68, processor 70, communication interface 60, and/or radio interface 62 is configured to cause the network node 16 to adjust a physical downlink control channel, PDCCH, monitoring window for the WD.

In some embodiments, the network node 16 such as by adaptation unit 32 in processing circuitry 68, processor 70, communication interface 60, and/or radio interface 62 is configured to cause the network node 16 to determine the channel condition of the physical uplink channel based at least in part on a target block error rate, BLER. In some embodiments, the network node 16 such as by adaptation unit 32 in processing circuitry 68, processor 70, communication interface 60, and/or radio interface 62 is configured to cause the network node 16 to determine the channel condition of the physical uplink channel by being configured to cause the network node to obtain a measurement of the physical uplink channel. In one embodiment, the measurement is a measurement of a signal to interference plus noise ratio, SINR, and the physical uplink channel is a physical uplink control channel, PUCCH.

In some embodiments, the number of HARQ bits to support is a maximum number of downlink HARQ bits associated with the WD. In some embodiments, the adjustment to support the number of HARQ bits is performed when the channel condition of the physical uplink channel is unable to support the number of HARQ bits.

In some embodiments, performing the adjustment comprises one or more of: applying, such as via adaptation unit 32, processing circuitry 68, processor 70 and/or radio interface 62, link adaptation to the physical uplink channel to adjust the number of HARQ bits; adjusting, such as via adaptation unit 32, processing circuitry 68, processor 70 and/or radio interface 62, the number of HARQ bits based on a power headroom report from the WD; adjusting, such as via adaptation unit 32, processing circuitry 68, processor 70 and/or radio interface 62, a number of cells configured to the WD; and/or adjusting, such as via adaptation unit 32, processing circuitry 68, processor 70 and/or radio interface 62, a physical downlink control channel (PDCCH) monitoring window for the WD.

In some embodiments, the method further includes determining, such as via adaptation unit 32, processing circuitry 68, processor 70 and/or radio interface 62, the channel condition based on a target block error rate (BLER). In some embodiments, the method further includes determining, such as via adaptation unit 32, processing circuitry 68, processor 70 and/or radio interface 62, whether the physical uplink channel can support the number of HARQ bits based on the channel condition and performing, such as via adaptation unit 32, processing circuitry 68, processor 70 and/or radio interface 62, the adjustment when the physical uplink channel is unable to support the number of HARQ bits.

Having described the general process flow of arrangements of the disclosure and having provided examples of hardware and software arrangements for implementing the processes and functions of the disclosure, the sections below provide details and examples of arrangements for DL HARQ-ACK bits driven by PUCCH/PUSCH link adaptations, which may be implemented by the network node 16, wireless device 22 and/or host computer 24.

Some embodiments of the present disclosure include managing (e.g., by NN 16) the number of DL transmissions based on expected maximum HARQ-ACK bits that can be supported (meeting certain decoding criteria) by uplink control/shared channel conditions. The maximum HARQ-ACK bits may be estimated (e.g., by NN 16) based on one or more of the following metrics.

In some embodiments, if estimation metrics 1 and 2, described below, are to be considered together and different HARQ bits are derived from them, the lower number of the HARQ-ACK bits may be used.

Metric 1: Adjust HARQ-ACK UCI with PUCCH link adaptation

Instead of configuring multiple PUCCH resource sets controlled by the coding rate, configure (e.g., by NN 16) minimal sets (e.g., PUCCH resource sets) that satisfy the system performance needs and control the number of DL transmissions (Tx) to achieve a desired coding rate based on PUCCH RF conditions within the defined resource sets.

The UL physical layer may provide PUCCH channel condition measurements on every reception of the WD's 22 HARQ-ACK feedback.

The PUCCH outer-loop adjustment to adjust the number of HARQ bits due to SINR relation accuracy based on the decoding status.

The NN 16 scheduler calculates the maximum number of DL transmissions according to the measurement and ensures the HARQ-ACK bits limit is satisfied.

$$The maximum number of DL HARQ bits = {f}_{p u c c h} ( Rx SINR , number of Rx branches ) .$$

Metric 2: Adjust HARQ-ACK UCI with PUSCH link adaptation (UCI on PUSCH)

Based on the UL channel condition and the WD's 22 power consumption limit, the WD 22 may report its power headroom (PH) medium access control (MAC) control element (CE) indicating the maximum number of PRBs it can use to transmit data on PUSCH. The PRBs PH is expected to be able to carry the required HARQ-ACK bits plus about n % current DL total throughput, where n % is the general user UL/DL traffic ratio based on the statistics toward the type of the traffic the user is used.

If the WD's 22 PH and current PUSCH channel quality indicates that the current maximum HARQ bits are too large or too few, which may impact the DL transmission performance, the NN 16 scheduler calculates the proper maximum number of DL transmissions accordingly.

Metric 3: Adjust number of configured scells

If the WD 22 is configured with carrier aggregation, adding/removing or activating/deactivating one or more scells may be another way of balancing the DL/UL traffic while the WD's 22 power consumption for monitoring PDCCH of its cell components can be saved. However, the above actions may include handshakes between the NN 16 and WD 22, so they are only applied when a long transition time for the HARQ-ACK bits change can be afforded.

### Embodiment 1 (E1): HARQ-ACK UCI Adjustment with PUCCH Link Adaptation

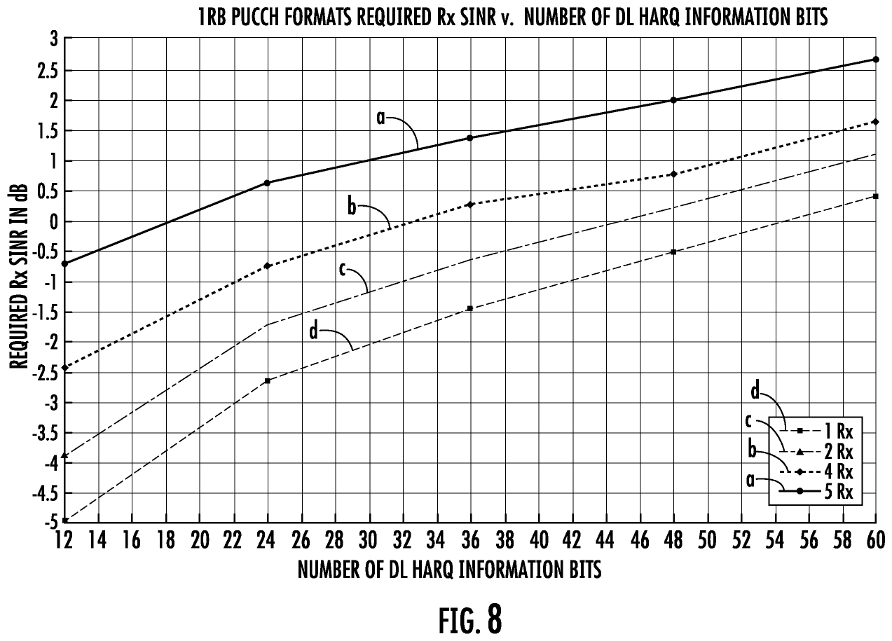

E1.1: A set of performance curves, as in FIG. 8, are provided and based on simulations on determining measured PUCCH channel conditions (interpreted as SINR) to the allowed maximum UCI bits UCI_{pucch}, which helps to ensure the decoding quality to meet all the following desired criteria based on various system configuration.

FIG. 8 illustrates a graph of the required (Rx) SINR vs. the maximum number of HARQ bits (BLER<=1%). In FIG. 8, the input is: Rx SINR and number of Rx branches and the output is: maximum number of HARQ bits allowed.

In some embodiments, the performance curves may be maintained by the NN 16 DL scheduler.

E1.2: The NN 16 DL scheduler may initialize a default harqBits_{pucch}, which is conservative but later to be adjusted in the steps as E1.3. The scheduler uses harqBits_{pucch} to cap the maximum number of DL data transmissions over all WD's 22 active carrier components that require the HARQ-ACK feed backs to be bundled and possibly transmitted over PUCCH of one cell (e.g., spcell) on one UL slot.

E1.3: Upon receiving a PUCCH measurement from the UL physical layer as sinrₘₑₐₛ, the NN 16 DL scheduler determines the maximum HARQ bits UCI_{pucch} going with sinrₘₑₐₛ+offset, based on the applied performance curve described as in E1.1 above.

By assuming current maximum HARQ bits is harqBits_{pucch}, the WD 22 configured SR bits is srBits:
If the channel condition gets better, it reflects as UCI_{pucch} is significantly larger than harqBits_{pucch}+srBits;
harqBits_{pucch} is to be increased to a reasonable gap range toward UCI_{pucch}−srBits;
Else, if the channel condition gets worse, UCI_{pucch} is getting close to harqBits_{pucch}+srBits or even larger;
harqBits_{pucch} is to be decreased to a reasonable gap range toward UCI_{pucch}−srBits but>=harqBitsₘᵢₙ;
Else, harqBits_{pucch} is still within the reasonable range around UCI_{picch}−srBits, keep as is;
Save or apply the desired maximum HARQ-ACK bits harqBits_{pucch} resulted from the above estimation.
End if

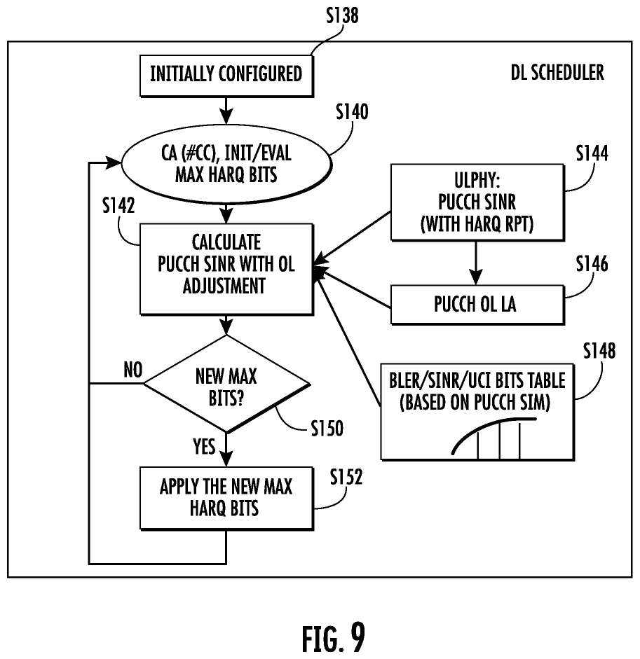

An example of a related flowchart is shown in FIG. 9, which may be performed by NN 16 and/or WD 22. In step S138, the WD 22 is initially configured with a default number of HARQ bits. In step S140, the NN 16 determines a maximum number of HARQ bits and a number of cells to configure the WD 22 with. In step S142, PUCCH SINR is calculated with a DL adjustment according to steps S144-S148, which include PUCCH SINR being calculated, PUCCH link adaption being performed and the number of maximum HARQ bits being adjusted based on, e.g., a table. In step S150, the NN 16 DL scheduler determines whether there is a new maximum number of HARQ bits. If no, the process returns to step S140 and the process repeats. If yes, the NN 16 DL scheduler applies the new maximum number of HARQ bits in step S152.

### Embodiment 2: HARQ-ACK UCI Adjustment with PUSCH Link Adaptation

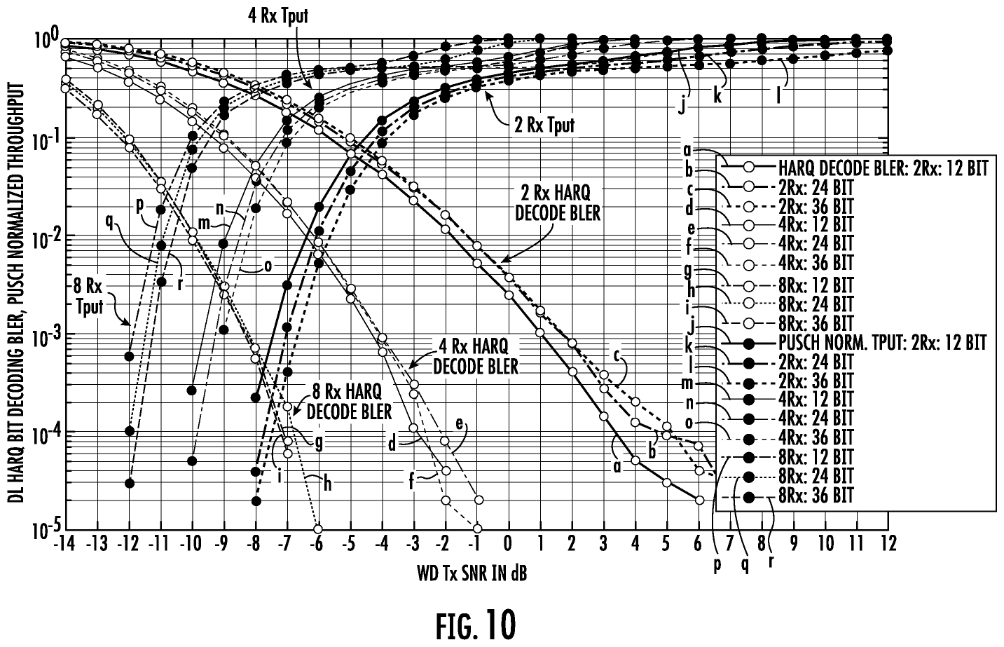

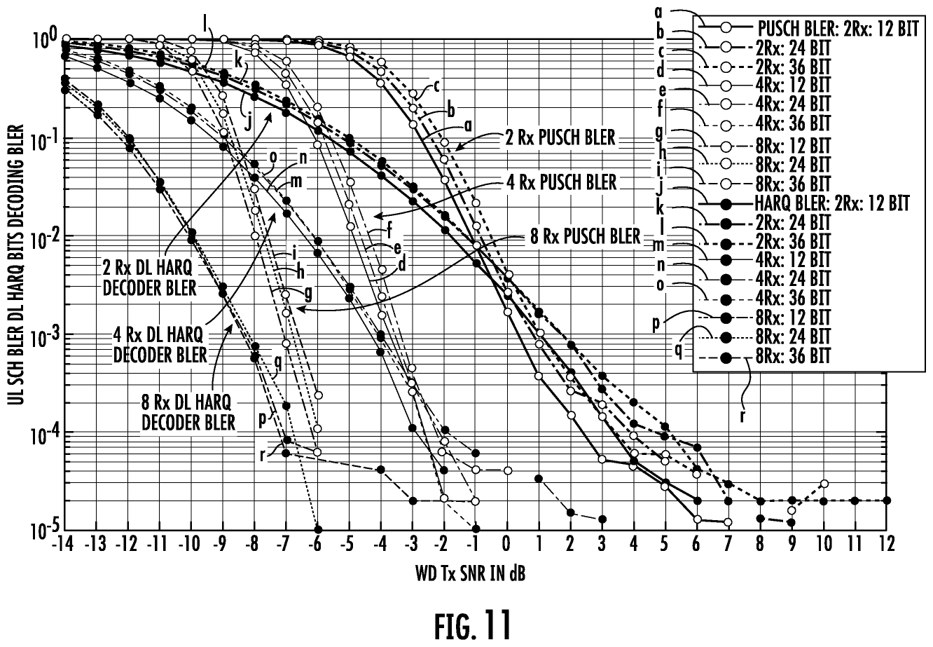

E2.1: A set of performance example curves, as shown in FIGS. 10 and 11, are provided by extensive simulations on determining performance of PUSCH channel conditions (interpreted as SINR) to determine the minimal PRBs that allow the number of HARQ-ACK bits as harqBits_{pusch}, along with minimal UL data to be transmitted with a desired BLER target.

Criteria: UL receive SINRᵣₓ, minimum UL data throughput, DL HARQ decoding performance metric (1% BLER, 1% ack missed, 0.1% nack to ack, 1% DTX to Ack, etc.).

Input: SINRᵣₓ, number of receive branches, number of PRBs.

Output: maximum number of DL HARQ bits.

The DL HARQ decoding BLER may be compared (e.g., by NN 16) against PUSCH throughput based on the number of PUSCH allocated number of resource blocks (RBs); it can be determined if the throughput is gating or DL HARQ decoding BLER (1%) is gating once the UL minimum throughput is determined.

FIG. 10 is a graph illustrating an example of HARQ decoding BLER vs. PUSCH normalized throughput.

FIG. 11 is a graph showing an example of the gating status between UL PUSCH data decoding BLER (target 10%) against the DL HARQ bits decoding BLER (1%).

FIG. 11 illustrates an example of PUSCH BLER vs. UCI HARQ Bits decoding BLER.

In some embodiments, the performance curves may be maintained by the NN 16 UL scheduler.

E2.2: If UCI on PUSCH is supported on the NN 16 system, the DL scheduler prepares that the HARQ-ACKs associated to the DL transmissions are to be carried on PUSCH where UL conditions cannot meet the criteria and thus, scales back on the DL transmissions scheduling.

The NN 16 DL scheduler initializes a default harqBits_{pusch}, which is conservative but later to be adjusted in the steps E2.3 and E2.4 above. The scheduler uses harqBits_{pusch} to cap the maximum number of DL data transmissions over all WD's 22 active carrier components that require the HARQ-ACK feed backs to be bundled and possibly transmitted as UCI over PUSCH of one cell (e.g., spcell) on one UL slot.

E2.3: The NN 16 UL scheduler accesses the WD's 22 latest DL throughput (tpt_{dl}) performance through the performance counters provided by the DL scheduler and derives the expected UL transport block (TB) size for the UL slot as:

$$( t b S i z {e}_{ul} ) = f ( {tpt}_{dl} ) ,$$

based on estimated traffic ratio between UL and DL (e.g., 10%), and applied time division duplex (TDD) pattern.

The NN 16 UL scheduler also accesses the WD's 22 latest power headroom that the WD 22 reported via MAC control elements. The NN 16 UL scheduler keeps/stores the value of harqBits_{pusch} that was last generated and reported to the DL scheduler.

E2.4: During the PUSCH resource allocation for the WD 22, when there is UL data to be transmitted, the NN 16 UL scheduler may perform one or more of the following:
If there are DL HARQ-ACK bits (harqBits) to be allocated, check the performance curves e.g., as indicated in E2.1, to determine the minimal PRBs, PRBₘᵢₙ(harqBits), with the bits and compare with the WD's 22 power headroom (PH). If min(PH, available PRBs)<PRBₘᵢₙ(harqBits), quit/stop the PUSCH scheduling. If PH<PRBₘᵢₙ(harqBits), search the curve for reducing HARQ-ACK bits, for example, harqBits_{pusch_new}>=harqBitsₘᵢₙ>0 that satisfy: PH>=PRBₘᵢₙ(harqBits_{pusch_new}).
NN 16 scheduler allocates UL resources for HARQ-ACK bits and UL data by using the PUSCH link adaptation.
Compare the scheduling result with the performance curves to determine a possible change of harqBits_{pusch}.
If PH allowed PRBs<PRB (harqBits_{pusch}, tbSizeᵤₗ), reduce harqBits_{pusch} until the following condition is satisfied, e.g.:
PH allowed PRBs>PRB (harqBits_{pusch_new}, tbSizeᵤₗ);
Else if PH allowed PRBs>>PRB (harqBits_{pusch}, tbSizeᵤₗ), and there is a room for conservatively increasing harqBits_{pusch} as:
harqBits_{pusch_new}=int (x*harqBits_{pusch}), where x>1; and
PH allowed PRBs>PRB (harqBits_{pusch_new}, x*tbSizeᵤₗ);
Else, keep the harqBits_{pusch} as is.
End if.
If harqBits_{pusch_new} is different from a previously reported value for harqBits_{pusch}, the NN 16 UL scheduler reports it to the DL scheduler and locally keeps/maintains/stores this new value.

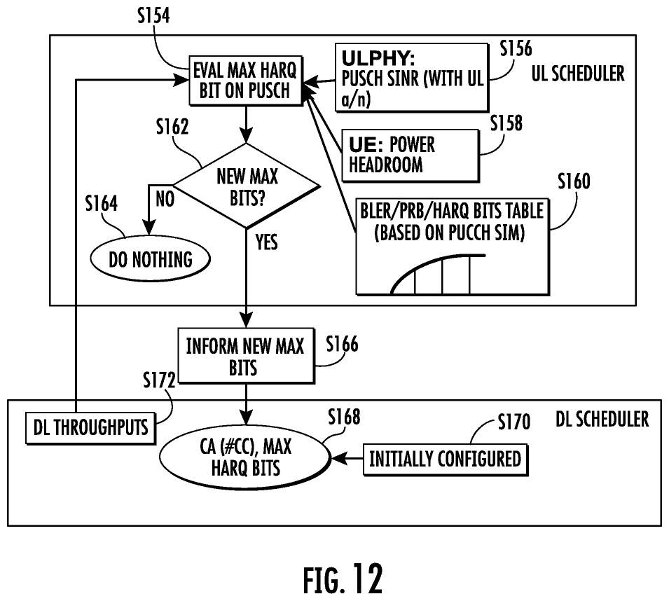

A related flowchart for is shown in FIG. 12, which may be performed by NN 16 and/or WD 22. In step S154, NN 16 UL scheduler evaluates the maximum number of HARQ bits on PUSCH. This may include steps S156-S160: NN 16 UL scheduler determines PUSCH SINR, receives power headroom report from the WD 22 and adjusts the maximum number of HARQ bits based on e.g., a table. In step S162, NN 16 UL scheduler determines whether there is a new maximum number of HARQ bits. If yes, the process may proceed to step S166 where the new maximum number of HARQ bits may be informed to the NN 16 DL scheduler. If no, the process proceeds to step S164, where nothing additional may be done. In step S168, NN 16 DL scheduler may determine the maximum number of HARQ bits. In step S170, NN 16 DL scheduler may initially configure a default number of HARQ bits (this may be used prior to receiving the maximum number of HARQ bits from the UL scheduler). In step S172, the NN 16 DL scheduler may determine the DL throughputs, which may be fed to the UL scheduler to use for evaluating the maximum HARQ bits on PUSCH.

### Embodiment 3: HARQ-ACK UCI Adjustment with PUCCH and PUSCH Link Adaptation

Check the desired maximum HARQ-ACK bits harqBits_{pucch} resulting from a PUCCH link adaption (LA) estimation (see e.g., Embodiment 1).

Check the desired maximum HARQ-ACK bits harqBits_{pusch} resulting from a PUSCH LA estimation (see e.g., Embodiment 2).

Apply harq Bitsₘₐₓ=min (harqBits_{pucch}, harqBits_{pusch}).

### Embodiment 4: The Same or Similar Concept as Described in Embodiments 1-3 May be Applied for Semi-Static HARQ-ACK Codebook

In some embodiments, the adjustment may instead be performed as follows: Instead of simply letting the NN 16 DL scheduler adjust the maximum HARQ bits, this embodiment may include one or more of the following, which may be performed by NN 16:
Adjust, e.g., add or reduce the number of scells configured to the WD 22;
Adjust, e.g., add or reduce the PDCCH monitor windows for the WD 22 toward all the involved carrier components.

This may include use of RRC configurations with the above changes for semi-static HARQ-ACK codebook.

Some embodiments may be arranged to improve network node system key performance indicator (KPI) performances through reliably decoding DL HARQ-ACKs and balancing DL/UL traffic based on UL channel conditions. Some embodiments may be arranged to allow potential massive DL throughputs through carrier aggregations; while avoiding over-configuring UL resources to maintain desired feedback quality and minimum UL throughput on poor UL coverage regions.

Some embodiments may include one or more of the following:

Embodiment A1. A network node configured to communicate with a wireless device (WD), the network node configured to, and/or comprising a radio interface and/or comprising processing circuitry configured to:
determine a channel condition of a physical uplink channel associated with the WD; and
based on the channel condition, perform an adjustment associated with the physical uplink channel to support a number of Hybrid Automatic Repeat reQuest (HARQ) bits.

Embodiment A2. The network node of Embodiment A1, wherein the network node and/or the radio interface and/or the processing circuitry is configured to perform the adjustment by being configured to one or more of:
apply link adaptation to the physical uplink channel to adjust the number of HARQ bits;
adjust the number of HARQ bits based on a power headroom report from the WD; and/or
adjust a number of cells configured to the WD; and/or
adjust a physical downlink control channel (PDCCH) monitoring window for the WD.

Embodiment A3. The network node of Embodiment A1, wherein the network node and/or the radio interface and/or the processing circuitry is configured to one or more of:
determine the channel condition based on a target block error rate (BLER); and/or
determine whether the physical uplink channel can support the number of HARQ bits based on the channel condition and perform the adjustment when the physical uplink channel is unable to support the number of HARQ bits.

Embodiment B1. A method implemented in a network node, the method comprising:
determining a channel condition of a physical uplink channel associated with the WD; and
based on the channel condition, performing an adjustment associated with the physical uplink channel to support a number of Hybrid Automatic Repeat reQuest (HARQ) bits.

Embodiment B2. The method of Embodiment B1, wherein performing the adjustment comprises one or more of:
applying link adaptation to the physical uplink channel to adjust the number of HARQ bits;
adjusting the number of HARQ bits based on a power headroom report from the WD;
adjusting a number of cells configured to the WD; and/or
adjusting a physical downlink control channel (PDCCH) monitoring window for the WD.

Embodiment B3. The method of Embodiment B1, further comprising one or more of:
determining the channel condition based on a target block error rate (BLER); and/or
determining whether the physical uplink channel can support the number of HARQ bits based on the channel condition and performing the adjustment when the physical uplink channel is unable to support the number of HARQ bits.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
Abbreviation Explanation
NR: New Radio
CA: Carrier Aggregation
PUCCH: physical uplink control channel
PUSCH: physical uplink shared channel
HARQ: Hybrid Automatic-Repeat-Request
SR: scheduling request

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a network node configured to communicate with a wireless device, WD, the method comprising:
determining a channel condition of a physical uplink channel associated with the WD; and
based on the channel condition, performing an adjustment associated with the physical uplink channel to support a number of Hybrid Automatic Repeat reQuest, HARQ, bits.

2. The method of claim 1, wherein the performing the adjustment comprises:
applying a link adaptation to the physical uplink channel to support the number of HARQ bits to transmit on the physical uplink channel.

3. The method of claim 1, wherein the performing the adjustment comprises:
adjusting the number of HARQ bits based at least in part on a power headroom report from the WD.

4. The method of claim 1, wherein the performing the adjustment comprises:
adjusting a number of cells configured to the WD.

5. The method of claim 1, wherein the performing the adjustment comprises:
adjusting a physical downlink control channel, PDCCH, monitoring window for the WD.

6. The method of claim 1, wherein the determining the channel condition of the physical uplink channel is based at least in part on a target block error rate, BLER.

7. The method of claim 1, wherein the determining the channel condition of the physical uplink channel comprises obtaining a measurement of the physical uplink channel.

8. The method of claim 7, wherein the measurement is a measurement of a signal to interference plus noise ratio, SINR, and the physical uplink channel is a physical uplink control channel, PUCCH.

9. The method of claim 1, wherein the number of HARQ bits to support is a maximum number of downlink HARQ bits associated with the WD.

10. The method of claim 1, wherein the adjustment to support the number of HARQ bits is performed when the channel condition of the physical uplink channel is unable to support the number of HARQ bits.

11. A network node configured to communicate with a wireless device, WD, the network node comprising processing circuitry, the processing circuitry configured to cause the network node to:
determine a channel condition of a physical uplink channel associated with the WD; and
based on the channel condition, perform an adjustment associated with the physical uplink channel to support a number of Hybrid Automatic Repeat reQuest, HARQ, bits.

12. The network node of claim 11, wherein the processing circuitry is configured to cause the network node to perform the adjustment by being configured to cause the network node to:
apply a link adaptation to the physical uplink channel to support the number of HARQ bits to transmit on the physical uplink channel.

13. The network node of claim 11, wherein the processing circuitry is configured to cause the network node to perform the adjustment by being configured to cause the network node to:
adjust the number of HARQ bits based at least in part on a power headroom report from the WD.

14. The network node of claim 11, wherein the processing circuitry is configured to cause the network node to perform the adjustment by being configured to cause the network node to:
adjust a number of cells configured to the WD.

15. The network node of claim 11, wherein the processing circuitry is configured to cause the network node to perform the adjustment by being configured to cause the network node to:
adjust a physical downlink control channel, PDCCH, monitoring window for the WD.

16. The network node of claim 11, wherein the processing circuitry is configured to cause the network node to determine the channel condition of the physical uplink channel based at least in part on a target block error rate, BLER.

17. The network node of claim 11, wherein the processing circuitry is configured to cause the network node to determine the channel condition of the physical uplink channel by being configured to cause the network node to obtain a measurement of the physical uplink channel.

18. The network node of claim 17, wherein the measurement is a measurement of a signal to interference plus noise ratio, SINR, and the physical uplink channel is a physical uplink control channel, PUCCH.

19. The network node of claim 11, wherein the number of HARQ bits to support is a maximum number of downlink HARQ bits associated with the WD.

20. The network node of claim 11, wherein the adjustment to support the number of HARQ bits is performed when the channel condition of the physical uplink channel is unable to support the number of HARQ bits.
